(19) United States
(12) Patent Application Publication
(10) Pub. No.: US 2025/0055264 A1
(43) Pub. Date: Feb. 13, 2025

(54) Cable Feeding Device Having a Coupling Unit for Detachably Coupling to a Pulling Means

(71) Applicant: Robert Bosch GmbH, Stuttgart (DE)

(72) Inventors: Fritz Schlegel, Stuttgart (DE); Andreas Schlegel, Leinfelden-Echterdingen (DE); Mario Ebel, Stuttgart (DE)

(21) Appl. No.: 18/791,670

(22) Filed: Aug. 1, 2024

(30) Foreign Application Priority Data
Aug. 7, 2023 (DE) 10 2023 207 551.2

(51) Int. Cl. H02G 1/08

(52) U.S. Cl. CPC H02G 1/081

(57) ABSTRACT

The disclosure relates to a cable feeding device having a transport unit for transporting a pulling device, in particular fish tape, provided for feeding cables into conduits, in particular a pulling device drum, for storing the pulling device in an at least largely enclosed manner. It is proposed that the cable feeding device comprises a coupling unit which is provided for a detachable, in particular direct, coupling to the pulling device, for example during a pulling device change.

This application claims priority under 35 U.S.C. § 119 to patent application no. DE 10 2023 207 551.2, filed on Aug. 7, 2023 in Germany, the disclosure of which is incorporated herein by reference in its entirety.

### BACKGROUND

Fish tape and/or cable pulling tools that manually operate on the principle of a cable drum are already known. In this case, the pulling means is generally fixedly and non-detachably connected to the cable drum or the tool.

### SUMMARY

The disclosure relates to a cable feeding device having a transport unit for transporting a pulling means provided for feeding cables in conduits, in particular fish tape, having at least one pulling means storage unit, in particular a pulling means drum, for storing the pulling means, preferably at least largely in an enclosed manner.

It is proposed that the cable feeding device comprises a coupling unit provided for detachably, in particular directly, coupling with pulling means, for example for replacing the pulling means.

By the design of the cable feeding device according to the disclosure, greater flexibility in use can advantageously be achieved because a plurality of different pulling means can advantageously be connected to a cable feeding device. Further advantageously, depending on the application, pulling means of different flexural rigidity or having a different material can be used. Furthermore, it may advantageously save costs for a user, because only different pulling means for a cable feeding device can be purchased and it is not necessary to purchase a plurality of cable feeding devices or pulling means drums.

The cable feeding device is in particular configured as a fish tape pulling system and/or as a cable pulling system. The cable feeding device is in particular provided at least to feed in pulling means, such as fish tapes or cables or the like. In addition, the cable feeding device may also be provided for dispensing and/or pushing of pulling means, such as fish tapes or ropes or the like. Fish tapes (also: electrician's snakes) are also known in particular as (cable) pulling tapes and are preferably provided for laying new lines, such as electrical lines, preferably wires, in walls or in cable guides, in particular conduits. The pulling means, in particular the fish tape, the cable, or the like, may have a circular cross-section, an oval cross-section, a polygonal cross-section, or a cross-section of a flat tape. In particular, the pulling means may be formed in multiple pieces, for example as a woven thread made of individual strands or as a twisted strand. Preferably, the cross section of the pulling means is at least substantially constant along a longitudinal extension of the pulling means. The pulling means may also be formed from different materials, for example at least partially from a plastic, such as a nylon, at least partially from a metal, such as from elastic spring steel, at least partially from a fiberglass strip, etc. In particular, “provided” and/or “configured” shall be understood to mean specially programmed, construed, and/or equipped. In particular, the phrase “an object being provided and/or configured for a specific function” is intended to mean that the object fulfills and/or performs said specific function in at least one application state and/or operating state.

The transport unit may be provided for transporting the pulling means in two transport directions opposite to one another. In particular, the transport unit is provided at least for pulling the pulling means. In addition, the transport unit may also be provided for pushing the pulling means. Typically, the transport unit is provided for both pulling and pushing the pulling means. Particularly preferably, the transport unit is configured to wind up and/or unwind the pulling means in the pulling means storage unit, in particular the pulling means drum, preferably on a storage shaft of the pulling means storage unit. Preferably, the transport unit comprises at least one drive unit. Preferably, the drive unit is provided for generating a driving force for winding up and/or unwinding the pulling means in the pulling means storage unit, in particular the pulling means drum, preferably onto the storage shaft of the pulling means storage unit. Preferably, the drive unit is an integral part of the cable feeding device, for example non-destructively inseparably connected to the pulling means storage unit, in particular to conveying elements of the transport unit of the pulling means.

Particularly preferably, the transport unit at least partially forms the pulling means storage unit. The movably supported storage shaft stored in the interior of a base body, in particular a pulling means enclosure, of the pulling means storage unit, may at least partially form the transport unit, e.g., by the transport unit being configured as a hub motor or the like, or by having a hub motor in addition to a roller drive in the region of a pulling means output able to rotate the movably mounted storage element. In particular, the storage shaft may comprise a rotational center axis/bearing axis preferably corresponding to a drum center axis of the pulling means drum about which the storage element rotates when conveying the pulling means. In this case, at least one drive interface of the transport unit may be rotationally fixedly and directly connected to the storage shaft. Alternatively, the transport unit forms a drive separate from the storage shaft, in particular at the pulling means output, in particular a pulling means discharge from the pulling means storage unit and/or a pulling means discharge from the cable feeding device, wherein the transport unit drives the pulling means in or out preferably by means of at least one, preferably at least two, rollers of the transport unit. Alternatively, the drive unit is configured to be separable, preferably from the pulling means storage unit, in particular from a conveying unit of the transport unit. The drive unit may be configured as a hand tool machine provided in particular in addition to a coupling of further attachments in addition to the cable feeding device. In particular, the conveying unit comprises the conveying elements and forms a mechanical transmission for transferring power from the drive unit to the conveying elements, in particular the pulling means. Alternatively, the hand tool machine may also be provided solely for coupling a cable feeding device or a plurality of different cable feeding devices comprising, e.g., different pulling means drums.

In particular, the fact that the pulling means storage unit is provided for storing the pulling means at least largely in a enclosed manner should be understood to mean that a majority of the components for storing the pulling means, in particular at least the storage shaft, are enclosed. Preferably, the pulling means is enclosed at least to a large extent in a coiled state of the pulling means, in particular enveloped. Particularly preferably, the transport unit drives the pulling means in or out during transport out of the pulling means storage unit. Preferably, in the coiled state of the pulling means, at least 70%, preferably at least 90% of the pulling means, is enclosed, and more preferably the entire pulling means is enclosed. In addition, “enclosing” is in particular to be understood as a wrapping of more than 50%, preferably more than 75%, and preferably more than 90% of a circumference of the pulling means in the coiled state in at least one circumferential direction, preferably in at least two circumferential directions extending in perpendicular planes. Preferably, the pulling means storage unit forms a pulling means enclosure for enclosing.

In particular, the pulling means storage unit at least partially forms a housing unit of the cable feeding device. Preferably, at least a large extent of the transport unit is enclosed by the housing unit. In particular, the housing unit at least partially supports the transport unit. In particular, the fact that the housing unit at least partially supports the transport unit should be understood to mean that at least 50%, preferably at least 75%, and preferably at least 90% of a total weight force of the transport unit acts on the housing unit.

In this context, the term “detachable” is in particular understood to mean “non-destructively separable”. In particular, the coupling of the coupling unit is manually detachable, particularly non-destructively separable, by means of a tool, in particular a hex wrench, screwdriver, and/or a tool specially developed for the coupling unit, and/or without any tool. Preferably, the coupling unit is configured to provide a coupling connection, in particular as a clamping connection and/or as a positive locking connection. Particularly preferably, the coupling unit is provided for coupling to a plurality of, particularly different, pulling means. Particularly preferably, the coupling unit provides the coupling, in particular the detaching and coupling for changing out the pulling means. Preferably, for changing out the pulling means, in particular the entire pulling means is detached from the coupling unit and/or attached to the coupling unit, preferably non-destructively. In particular, the coupling unit is provided for coupling, in particular for receiving, a further or the same pulling means, after detaching the pulling means. Preferably, the coupling unit is adapted to secure the pulling means to the pulling means storage unit, in particular the storage shaft. A “direct coupling” should in particular be understood to mean that the coupling unit is directly connected to the pulling means, in particular by engaging the coupling unit with at least a part of the pulling means, in particular directly connected to a coupling element of the pulling means, in particular at least partially continuing and preferably extending the pulling means. In particular, only the coupling unit is provided for directly coupling.

It is further proposed that the transport unit is configured to provide a coupling mode intended to provide the coupling unit with access, in particular allowing at least the changing of the pulling means. Access to the coupling unit can thereby advantageously be provided as easily as possible. Further, advantageously, undesired detaching of the pulling means may be prevented during operation of the cable feeding device. Furthermore, contamination of the coupling unit, in particular of the coupling point, can advantageously be reduced. Preferably, access to the coupling unit, in particular for changing the pulling means, is only provided in the coupling mode. Particularly preferably, the coupling mode can be set only by manually actuating the transport unit, preferably by a user, and/or by automatically actuating the transport unit, preferably by a control and/or regulating unit. Preferably, when the transport unit is manually actuated, access to the coupling unit is provided regularly by means of activating the transport unit to unwind the pulling means, wherein preferably after completely unwinding the pulling means by means of the transport unit, the coupling mode can be set, in particular the access to the coupling unit can be provided. Preferably, the coupling mode is unlockable when the transport unit is driven automatically by means of a control and/or regulating unit, in particular by actuating a coupling switch. The term “control and/or regulating unit” should in particular be understood to mean a unit comprising at least one electronic control. The term “electronic control” should in particular be understood to mean a unit comprising a processor unit and comprising a memory as well as an operating program stored in the memory. In particular, the control and/or regulating unit comprises a receiving module for receiving signals of an operator interface of the cable feeding device, in particular the coupling switch. In particular, the control and/or regulating unit comprises a transmission module for transmitting control commands to the transport unit, in particular the drive unit.

In addition, it is proposed that the transport unit is configured to provide a coupling mode in which at least a portion of the coupling unit, in particular at least one coupling element of the coupling unit making contact with the pulling means, is disposed outside the pulling means storage unit, in particular outside a pulling means enclosure formed by the pulling means storage unit. The coupling unit can thereby advantageously be made directly accessible in the coupling mode. Preferably, in the coupling mode, the transport unit is configured to further drive out the pulling means, in particular after completely unwinding the pulling means, so that the coupling element in particular is disposed outside the pulling means storage unit. In particular, in the coupling mode, the pulling means is disposed entirely out of the pulling means storage unit, in particular driven out. In particular, the coupling element is provided for providing the clamping connection and/or positive locking connection, for example as a clamp, connector, screw clamp, lug clamp, snap hook, or the like. Preferably, the pulling means comprises a coupling element corresponding to the coupling element of the coupling unit. Particularly preferably, the coupling element is configured as a coupling pin in particular provided for detachably coupling into a recess of the coupling element of the pulling means. Preferably, in the coupling mode, the coupling unit is disposed at least partially or the coupling element is completely outside the housing unit of the cable feeding device. Preferably, in the coupling mode, the pulling means is completely outside of the pulling means storage unit, preferably wherein the pulling means is completely unwound from the storage shaft. Preferably, in the coupling mode, the transport unit is provided to drive the coupling element, which is in particular in contact with the pulling means, preferably for detachably fastening, out of the pulling means storage unit. Particularly preferably, in the coupling mode, the coupling element is accessible, in particular to the user.

Furthermore, it is proposed that the transport unit is configured to provide an operation mode, wherein the coupling unit, in particular at least one coupling element of the coupling unit, is disposed within the pulling means storage unit, in particular within a pulling means enclosure formed by the pulling means storage unit. An undesired detaching of the pulling means in the operation mode can thereby be advantageously prevented. Furthermore, contamination of the coupling unit, in particular of the coupling point, can advantageously be reduced in the operation mode. Preferably, in the operation mode, the transport unit is provided to drive the pulling means into the conduit and/or to draw the cables into the conduit by means of the pulling means. Preferably, the cable feeding device comprises at least one operation switch for the operation mode for actuating the transport unit to drive out and/or drive in the pulling means. In particular, the coupling unit, in particular the coupling element, is at least partially wound on the storage shaft in the operation mode.

In at least one embodiment of the device according to the disclosure, the operation switch for the operation mode is provided for providing access to the coupling unit for changing from the operation mode to the coupling mode, wherein the pulling means, in particular at least partially the coupling unit, preferably the coupling element, is driven out of the pulling means enclosure, in particular further unwound by means of the operation switch, until the coupling element is disposed outside of the pulling means enclosure. In at least one further embodiment of the device according to the disclosure, the control and/or regulating unit is provided to change from the operation mode to the coupling mode in order to provide access to the coupling unit. Preferably, the cable feeding device comprises at least the coupling switch provided for switching between the operation mode and the coupling mode.

It is further proposed that the coupling unit comprises at least the coupling element for making contact with the pulling means or with the coupling element of the pulling means and at least one connecting element to an arrangement of the coupling element on the pulling means storage unit and/or the transport unit. As a result, the coupling element, in particular the coupling point, can be advantageously driven out of the pulling means storage unit as easily as possible for access, in particular without opening the pulling means storage unit. Preferably, in the operation mode, the connecting element is disposed in the pulling means storage unit. Preferably, the connecting element connects the coupling element, in particular the pulling means, to the pulling means storage unit, in particular the storage shaft. Preferably, the connecting element is fixedly connected to the pulling means storage unit, in particular the storage shaft. In particular, the connecting element is fixedly connected to the coupling element of the coupling unit. Preferably, the connecting element guides the coupling element, in particular the coupling point to the pulling means, from within the pulling means storage unit, in particular the storage shaft, to outside the pulling means storage unit for providing access. In particular, in the coupling mode, the connecting element is disposed partially outside of and partially inside the pulling means storage unit.

In addition, it is proposed that the connecting element is configured to be windable and that the pulling means be pushed out of the pulling means storage unit. This advantageously ensures a safe driving out of the coupling element in the coupling mode. Furthermore, an unrestricted operation of the cable feeding device in the operation mode can advantageously be ensured, in particular without restriction by the coupling element. Preferably, the connecting element is at least substantially similar to a rope. In particular, the connecting element is at least partially flexible so that, in particular in the operation mode, the connecting element is coiled in the pulling means storage unit, in particular on the storage shaft. Preferably, the connecting element is at least partially flexurally rigid. Preferably, a flexural rigidity of the connecting element is selected such that the connecting element pushes out the pulling means, in particular independently, preferably driven by the transport unit. In particular, the flexural rigidity of the connecting element corresponds at least approximately to the flexural rigidity of the pulling means, in particular, a material of the connecting element is at least substantially according to the pulling means, for example a nylon, at least partially made of a metal, for example elastic spring steel, at least partially made of a glass fiber strip, etc. In particular, the flexural rigidity of the connecting element is at least 5%, preferably at least 10%, advantageously at least 20%, and particularly preferably at least 50% greater than the flexural rigidity of the pulling means.

Further, it is proposed that the cable feeding device comprises at least the control and/or regulating unit provided at least for controlling the transport unit to execute the coupling mode and/or the coupling unit to establish or release the coupling with the pulling means. As a result, an advantageous convenience in setting the coupling mode can be further promoted. In particular, the control and/or regulating unit is provided to provide a change between the operation mode and the coupling mode, in particular to actuate the transport unit according to the operation mode or the coupling mode. Preferably, in the operation mode, the control and/or regulating unit blocks access to the coupling mode, in particular, controls the transport unit, such that the coupling element is in the pulling means storage unit. Preferably, in the coupling mode, the control and/or regulating unit blocks access to the operation mode, in particular controls the transport unit such that the pulling means is completely unwound. Preferably, the control and/or regulating unit is switchable with between the operation mode and the coupling mode by means of the coupling switch.

It is further proposed that the control unit comprises a communication interface provided at least for receiving a communication signal from an external unit for triggering the coupling mode. As a result, an external control of the cable feeding device, in particular the transport unit, can advantageously be provided preferably for setting the coupling mode and/or the operation mode. In particular, the communication interface is a wireless and/or physical communication interface, in particular a cellular interface, Wi-Fi interface, Bluetooth interface, NFC interface, USB interface, and/or the like. Preferably, the communication signal is a corresponding signal from the communication interface, in particular for establishing a communication link. A “communication link” is intended in particular to mean a connection through which a control and/or regulating unit is or becomes connected to further control and/or regulating units, whereby the units can communicate with one another and exchange data and/or control signals. Preferably, the external unit is an operator element, in particular a smartphone, a tablet, a laptop, a remote control, and/or the like, which communicates with the control and/or regulating unit, preferably via an application.

Further, it is proposed that the control and/or regulating unit is restricted in access. Advantageously, security of the cable feeding device may thereby be increased. Furthermore, it can be advantageously ensured, in particular by using the application on the smartphone, that only the user can change out the pulling means, in particular the user that is connected to the cable feeding device via the application. Preferably, a change to the coupling mode is limited, in particular, wherein operation in the operation mode in particular does not require access. Alternatively, the coupling mode and the operation mode are restricted by the control and/or regulating unit. Preferably, the control and/or regulating unit is password protected and/or similarly encrypted. In particular, the communication interface is provided, in particular triggered by the communication signal of the external unit, to unlock the control and/or regulating unit. Alternatively and/or additionally, the cable feeding device comprises at least one input field provided for unlocking the control and/or regulating unit.

Furthermore, a system is proposed having the cable feeding device and having at least the pulling means. By the system according to the disclosure, a higher deployment flexibility can advantageously be achieved, because advantageously, the pulling means can be detached and/or removed by means of a cable feeding device depending on the application. Furthermore, if the system comprises a plurality of pulling means, different pulling means can be advantageously coupled to the cable feeding device depending on the application. Preferably, the system comprises the pulling means having at least one coupling element provided for coupling to the coupling unit, in particular the coupling element, of the cable feeding device.

Furthermore, it is proposed that the system comprises a receiving unit configured to dispense and/or take up the pulling means, preferably directly, upon unwinding and/or winding of the pulling means, in particular in a coupling mode. Immediate storing of the pulling means to be changed can thereby advantageously be provided for a pulling means change. Advantageously, convenience of the system can thus be increased. Furthermore, order may advantageously be further increased. In particular, the receiving unit is configured as a pulling means storage, in particular as an external drum and/or a manual winding unit, which dispenses and/or receives the pulling means during a pulling means change, in particular unwinds and/or winds the same onto the drum. In particular, the manual winding unit can be advantageously transported in a toolbox. In particular, the receiving unit is provided for directly dispensing and/or receiving, wherein preferably, the storage unit receives the pulling means into the receiving unit at the same time as the pulling means is unwinding, in particular unwinding onto the drum, and/or simultaneously when the pulling means is unwinding, particularly after the coupling to the coupling unit is established, which dispenses the pulling means from the receiving unit, in particular from the drum. Preferably, the transport unit drives the dispensing and/or receiving of the receiving unit. Preferably, a pulling means head of the pulling means is attachable to the receiving unit for receiving the pulling means. Alternatively and/or additionally, the receiving unit comprises at least one further transport unit, which actively dispenses and/or receives the pulling means. Preferably, the control and/or regulating unit is provided when the coupling switch is actuated several times to drive the further transport unit of the receiving unit.

In addition, a pulling means for the system is proposed having the coupling element provided for coupling to at least the coupling unit of the cable feeding device. By means of the pulling means according to the disclosure, a greater flexibility in use can advantageously be achieved, because a plurality of different cable feeding devices can advantageously be connected to one pulling means. Further, advantageously, depending on the application, cable feeding devices having different power and/or size may be applied.

Further, a set of pulling means is proposed having a plurality of different pulling means each having at least one coupling element provided for coupling to a coupling unit of a cable feeding device. By the pulling means set according to the disclosure, greater flexibility in use can advantageously be achieved, because advantageously several different pulling means from the pulling means set can be connected to a cable feeding device. Further, advantageously, depending on the application, pulling means from the set of pulling means can be applied having different flexural rigidity or having a different material. In particular, each pulling means of the pulling means set has different properties, in particular different materials, and/or different lengths and/or cross sections, and/or different grip elements for cables to be fed into the conduits. Preferably, the coupling elements of the pulling means of the pulling means set are identical, in particular, all are provided for coupling to a cable feeding device.

The cable feeding device according to the disclosure, the system according to the disclosure, the pulling means according to the disclosure and the pulling means set according to the disclosure are not intended to be limited to the application and embodiment described above. In particular, the cable feeding device according to the disclosure, the system according to the disclosure, the pulling means according to the disclosure, and the pulling means set according to the disclosure may have a number of individual elements, components and units that differs from a number specified herein in order to fulfill a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. An exemplary embodiment of the disclosure is shown in the drawings. The drawings, the description, and the disclosure contain numerous features in combination. A person skilled in the art will appropriately also consider the features individually and combine them into additional advantageous combinations.

Shown are:

FIG. 1 a system having a cable feeding device, a pulling means, and a receiving unit,

FIG. 2 the cable feeding device having the pulling means,

FIG. 3 the cable feeding device having the pulling means in a coupling mode, having access to a coupling unit,

FIG. 4 the coupling unit of the cable feeding device coupled to a coupling element of the pulling means, and

FIG. 5 a set of pulling means having a plurality of pulling means.

### DETAILED DESCRIPTION

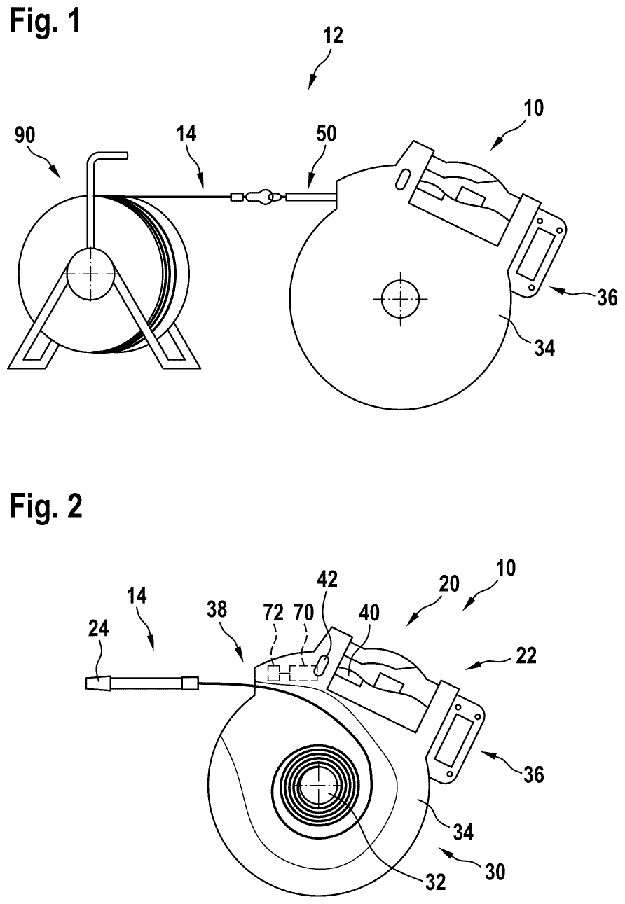

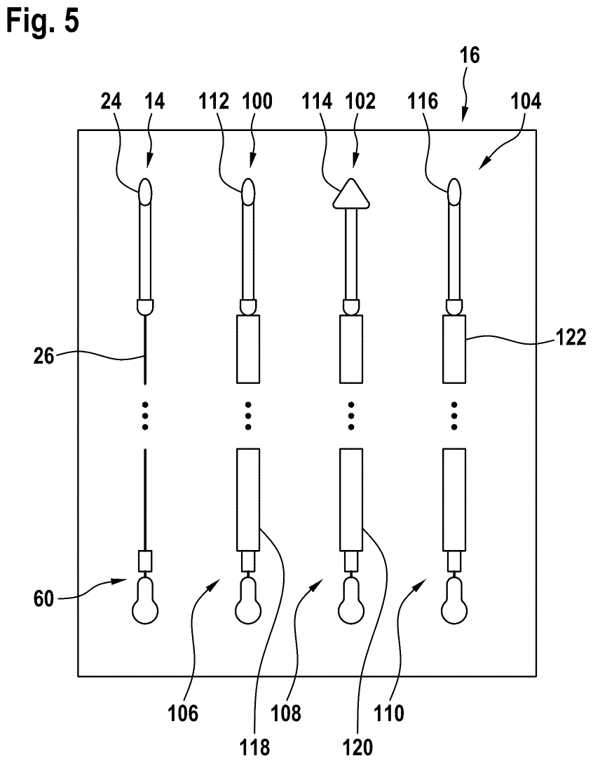

FIG. 1 shows a schematic perspective view of a system 12 having a cable feeding device 10 and having a drive device. The system 12 comprises the cable feeding device 10. The system 12, in particular the cable feeding device 10, comprises a pulling means 14. The pulling means 14 is provided at least for feeding cables, in particular electrical wires, into conduits. The pulling means 14 is provided to transmit a pulling force of the system 12 to the cable. The pulling means 14 comprises a pulling means head 24. The pulling means 14 comprises a pulling means cable 26 (cf. FIG. 2). The pulling means head 24 is provided for reversibly attaching the cable to the pulling means 14, for feeding the cable into conduits. The pulling means 14, in particular the pulling means cable 26, is configured as a wire strand made of spring steel, for example. The pulling means 14 is part of a pulling means set 16 (cf. FIG. 5). However, other embodiments of the pulling means 14 are also conceivable.

The cable feeding device 10 is shown in a coupling mode in FIG. 1. The coupling mode is provided for a pulling means change. The coupling mode is provided for assembly/disassembly of the pulling means 14. The cable feeding device 10 comprises at least one coupling unit 50. The coupling unit 50 is provided for detachably coupling to the pulling means 14. The coupling unit 50 provides non-destructive separating of the pulling means 14 from the cable feeding device 10. The system 12 comprises a receiving unit 90. The receiving unit 90 is configured to dispense and/or receive the pulling means 14 upon unwinding and/or winding up of the pulling means 14. The receiving unit 90 is a pulling means storage outside of the cable feeding device 10. The receiving unit 90 is configured as an external drum. The drum, when unwinding and/or winding up the pulling means 14 from the cable feeding device 10, winds up and/or unwinds the pulling means 14.

The receiving unit 90 is configured to dispense and/or receive the pulling means 14 when unwinding and/or winding up the pulling means 14 in the coupling mode. The receiving unit 90 directly receives the pulling means 14 upon dispensing of the pulling means 14 from the cable feeding device 10. The receiving unit 90 directly receives the pulling means 14 upon receiving the pulling means 14 into the cable feeding device 10. The receiving unit 90 receives the pulling means 14 simultaneously with an unwinding of the pulling means 14. The receiving unit 90 simultaneously dispenses upon winding up of the pulling means 14. The receiving unit 90 dispenses the pulling means 14 after establishing the coupling between the pulling means 14 and the coupling unit 50 of the cable feeding device 10. The dispensing and/or receiving of the receiving unit 90 is driven by the cable retracting device 10. Alternatively and/or additionally, the receiving unit 90 comprises at least one transport unit 20. The transport unit 20 of the receiving unit 90 actively dispenses the pulling means 14 during a pulling means change and/or actively receives the pulling means 14. The pulling means head 24 of the pulling means 14 is attachable to the receiving unit 90 for receiving the pulling means 14.

FIG. 2 shows a schematic perspective view of the cable feeding device 10 in an operation mode with the coiled pulling means 14. The pulling means 14 is mounted to the cable retractor 10 in the operation mode. The cable feeding device 10 comprises a housing unit 36. The cable feeding device 10 comprises a pulling means storage unit 30. The pulling means storage unit 30 is provided for storing the pulling means 14 at least largely in an enclosed manner. The pulling means storage unit 30 is provided for storing the pulling means 14. The pulling means storage unit 30 is fixedly connected, in particular inseparably, to the housing unit 36. The pulling means storage unit 30 is formed at least partially integrally with the housing unit 36.

The pulling means storage unit 30 includes a pulling means enclosure 34 enclosing at least a majority of the pulling means 14 in the coiled state. The pulling means enclosure 34 forms a storage space for the coiled pulling means 14. The pulling means storage unit 30 is configured as a pulling means drum. The pulling means enclosure 34 forms a storage space for a rotational storage shaft 32. The storage shaft 32 is supported (rotationally) movably in the pulling means enclosure 34. The storage shaft 32 is provided for winding and unwinding the pulling means 14. The storage shaft 32 forms a winding axis. The pulling means 14 is wound and/or unwound around the winding axis in the pulling means unit. The winding axis is in particular identical to a storage axis of the pulling means storage unit 30.

The pulling means storage unit 30 has a pulling means discharge 38. The pulling means 14 exits the pulling means storage unit 30 at the pulling means discharge 38. The pulling means storage unit 30 is cylindrical. The pulling means discharge 38 is disposed on the outer circumference of a lateral surface of the cylindrical pulling means storage unit 30.

The cable feeding device 10 comprises a transport unit 20. The housing unit 36 partially encloses the transport unit 20. The housing unit 36 supports the transport unit 20. The transport unit 20 is disposed on an outer circumference on a lateral surface of the cylindrical pulling means storage unit 30. The transport unit 20 is provided for transporting the pulling means 14 along at least one transport direction, in particular along at least two transport directions. The transport unit 20 is provided for transporting along a feeding direction and/or along a dispensing direction. The transport unit 20 is provided for pulling the pulling means 14 in a cable feeding operation. The transport unit 20 is provided for pushing the pulling means 14 during an insertion process in which the pulling means 14 is threaded and inserted into the conduit. The transport unit 20 is provided to drive the pulling means 14 into and/or out of the pulling means storage unit 30 during transport.

The transport unit 20 is configured to wind up and/or unwind the pulling means 14 in the pulling means storage unit 30. The transport unit 20 is configured to wind and/or unwind the pulling means 14 on the storage shaft 32. The transport unit 20 comprises at least one drive unit 22. The drive unit 22 is provided to generate a motive force that winds and/or unwinds the pulling means 14 in the pulling means storage unit 30 on the storage shaft 32 of the pulling means storage unit 30. The drive unit 22 is an integral part of the cable feeding device 10, which is connected, for example, non-destructively inseparably to the pulling means storage unit 30 and the conveying elements of the transport unit 20 of the pulling means 14. In an alternative embodiment of the cable feeding device 10, the housing unit 36 comprises at least one housing interface. An external drive unit 22 can be coupled to the cable feeding device 10 via the housing interface. For example, the external drive unit 22 is a hand tool machine.

The transport unit 20 at least partially forms the pulling means storage unit 30. The transport unit 20 is at least partially configured as a hub motor, which rotates the movably supported storage shaft 32. The storage shaft 32 has a rotational center axis/storage axis, which preferably corresponds to a drum center axis of the pulling means drum about which the bearing element is rotated when conveying the pulling means. The transport unit 20 has a drive interface that is rotationally fixed and directly connected to the storage shaft 32.

The transport unit 20 is configured to provide an operation mode. The operation mode is provided for regular operation of the cable retractor 10. In the operation mode, the transport unit 20 is provided to drive the pulling means 14 into the conduit and/or to feed the cables into the conduit with the pulling means 14. The cable feeding device 10 has at least one operating switch 40 for the operation mode. The operation switch 40 is provided for driving the transport unit 20. The operation switch 40 is provided to drive the transport unit 20 to drive out and/or drive in the pulling means 14. For complete winding of the pulling means 14, the transport unit 20 is provided to obtain a minimum distance of the pulling means 14 outside the cable feeding device 10. At least the pulling means head 24 is visible at the minimum distance.

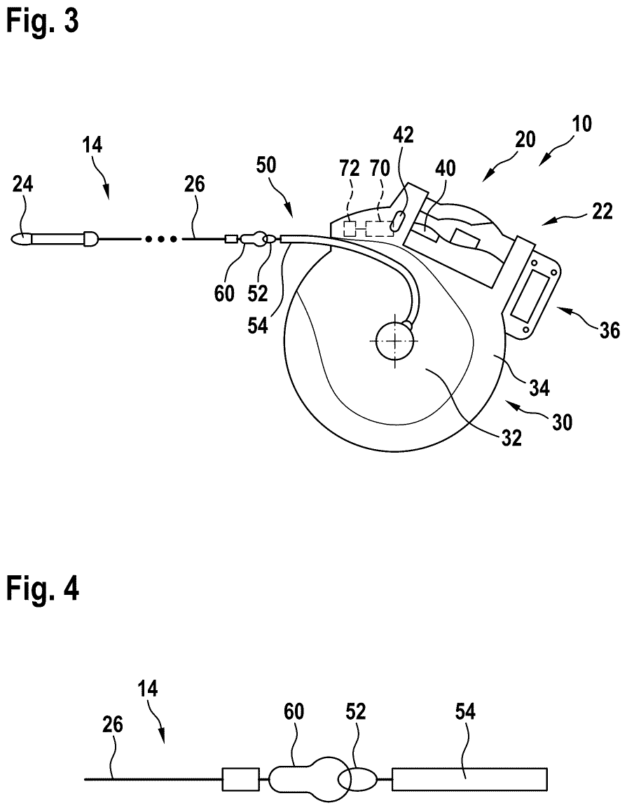

FIG. 3 shows a schematic perspective view of the cable feeding device 10 having the pulling means 14 in the coupling mode. In the coupling mode, access to the coupling unit 50 is provided. The coupling unit 50 comprises a coupling element 52. The coupling element 52 is provided for establishing contact with the pulling means 14. The coupling element 52 is provided for establishing contact with a coupling element 52 of the pulling means 14. Also compare FIG. 4, which is a schematic perspective view of the coupling point of the coupling unit 50 of the cable feeding device 10 and the coupling element 52 of the pulling means 14. The coupling of the coupling unit 50 is detachable with a tool and/or by hand. Preferably, the coupling unit 50 is configured to provide a coupling connection, in particular as a clamping connection and/or as a positive locking connection. The coupling unit 50 is provided, after detaching the pulling means 14, for coupling a further or the same pulling means 14. For example, the coupling element 52 is a coupling ring. The pulling means 14 has a coupling element 52 corresponding to the coupling element 52 of the coupling unit 50. For example, the pulling means 14 comprises a snap hook as the coupling element 52 provided for coupling to the coupling ring.

The coupling unit 50 is configured to attach the pulling means 14 to the pulling means storage unit 30. The coupling unit 50 is configured to attach the pulling means 14 to the transport unit 20. The coupling unit 50 is configured to attach the pulling means 14 to the storage shaft 32. The coupling unit 50 comprises at least one connecting element 54. The connecting element 54 is provided for an arrangement of the coupling element 52 on the pulling means storage unit 30. The connecting element 54 is provided for an arrangement of the coupling element 52 on the pulling means storage unit 20. The connecting element 54 attaches the coupling element 52 to the storage shaft 32.

The connecting element 54 is disposed in the operation mode in the pulling means storage unit 30. The connecting element 54 connects the coupling element 52 to the pulling means storage unit 30. The connecting element 54 connects the pulling means 14 to the storage shaft 32. The connecting element 54 is fixedly connected to the pulling means storage unit 30. The connecting element 54 is fixedly connected to the storage shaft 32. The connecting element 54 is fixedly connected to the coupling element 52 of the coupling unit 50. The connecting element 54 guides the coupling element 52 from within to outside the pulling means storage unit 30 to provide access to the pulling means 14 at the coupling point. The connecting element 54 in the coupling mode is disposed partially external and partially internal to the pulling means storage unit 30. The connecting element 54 is disposed fully internally in the operation mode.

The connecting element 54 is configured to be windable. The connecting element 54 is provided for pushing out the pulling means 14 from the pulling means storage unit 30 30. The connecting element 54 is at least substantially ropelike. The connecting element 54 is at least partially flexible such that the connecting element 54 is wound on the storage shaft 32 in the operation mode in the pulling means storage unit 30. The connecting element 54 is at least partially bending stiff. The flexural rigidity of the connecting element 54 is selected such that the connecting element 54 extends the pulling means 14 driven by the transport unit 20. The flexural rigidity of the connecting element 54 is at least approximately the flexural rigidity of the pulling means 14.

The transport unit 20 is provided to provide the coupling mode. In the coupling mode, the transport unit 20 is provided to provide access to the coupling unit 50. In the coupling mode, the transport unit 20 is provided to provide access to the coupling unit 50 for the pulling means change. Access to the coupling unit 50 is provided only in the coupling mode. In the coupling mode, at least a portion of the coupling unit 50 is disposed outside of the pulling means enclosure 34 formed by the pulling means storage unit 30. In the coupling mode, at least one coupling element 52 of the coupling unit 50, which makes contact with the pulling means 14, forming by the pulling means storage unit 30 is disposed outside of the pulling means enclosure 34. In the coupling mode, the coupling unit 50 is disposed at least partially or the coupling element 52 completely outside the housing unit 36 of the cable feeding device 10.

In the coupling mode, the transport unit 20 further drives the pulling means 14 after a complete unwind of the pulling means 14 such that the coupling element 52 is disposed outside the pulling means storage unit 30. In the coupling mode, the pulling means 14 is completely outside of the pulling means storage unit 30. In the coupling mode, the pulling means 14 is completely unwound from the storage shaft 32. The coupling element 52 is accessible to a user for the pulling means change in the coupling mode. In the coupling mode, the transport unit 20 propels the coupling element 52 out of the pulling means enclosure 34 at least one minimum length, at least such that the coupling element 52 is visible.

In the operation mode of the transport unit 20, the coupling unit 50 is disposed within the pulling means storage unit 30. In the operation mode of the transport unit 20, the coupling unit 50 is disposed within the pulling means enclosure 34 formed by the pulling means storage unit 30. In the operation mode, at least the coupling element 52 of the coupling unit 50 which makes contact with the pulling means 14 is arranged within the pulling means storage unit 30. In the operation mode of the transport unit 20, the coupling element 52 of the coupling unit 50, which makes contact with the pulling means 14, is disposed within the pulling means enclosure 34 formed by the pulling means storage unit 30. The coupling unit 50 is at least partially wound on the storage shaft 32 in the operation mode. The coupling element 52 is wound on the storage shaft 32 in the operation mode. The connecting element 54 is wound on the storage shaft 32 in the operation mode.

The cable feeding device 10 comprises at least one control and/or regulating unit 70. The control and/or regulating unit 70 is provided for setting the coupling mode. The control and/or regulating unit 70 is provided for actuating the transport unit 20 to provide the coupling mode. The control and/or regulating unit 70 is provided to switch from the operation mode to the coupling mode to provide access to coupling unit 50. The cable feeding device 10 comprises at least one coupling switch 42. The coupling switch 42 is provided for switching between the operation mode and the coupling mode. The coupling switch 42 is provided for a control of the control and/or regulating unit 70. The coupling switch 42 enables the coupling mode to be unlocked and the transport unit 20 to be controlled accordingly such that access to the coupling unit 50 is provided.

The control and/or regulating unit 70 is provided at least to actuate the transport unit 20 to an embodiment of the coupling mode and/or the coupling unit 50 to establish or release the coupling to the pulling means 14. The control and/or regulating unit 70 is provided to control the transport unit 20 according to the operation mode or coupling mode. In the operation mode, the control and/or regulating unit 70 blocks access to the coupling mode. The control and/or regulating unit 70 controls the transport unit 20 in the operation mode such that the coupling element is within the pulling means storage unit 30. In the coupling mode, the control and/or regulating unit 70 blocks access to the operation mode. The control and/or regulating unit 70 controls the transport unit 20 in the coupling mode such that the pulling means 14 is fully unwound.

The control unit 70 is an electrical unit having at least one control electronics. In particular, the control unit comprises at least one processor and one memory element, as well as an operating program stored on the memory element. In particular, the control and/or regulating unit 70 comprises a receiving module for receiving signals of an operator interface of the cable feeding device 10, in particular the coupling switch. The receiving module is provided for receiving signals from the coupling switch 42. The receiving module is provided for receiving signals from the operating switch 40. In particular, the control and/or regulating unit 70 comprises a transmission module for transmitting control commands to the transport unit 20.

In at least one further embodiment of the cable feeding device 10 according to the disclosure, the coupling mode can be set by manually actuating the transport unit 20. Access to the coupling unit 50 is provided via the actuation of the transport unit 20 by means of the operation switch 40 to unwind the pulling means 14. The operation switch 40 is provided with the transport unit 20 to at least partially drive the coupling unit 50 out of the pulling means enclosure 34. The operation switch 40 is provided to drive the transport unit 20 such that the coupling unit 50 is at least partially driven out of the pulling means enclosure 34. Only with the operation switch 40 can the change between the operation mode and the coupling mode be made. It is conceivable that the control and/or regulating unit 70 will have at least one sensor that senses a winding state of the pulling means 14 in the pulling means storage unit 30. According to the winding state, the control and/or regulating unit 70 is provided to switch between the operation mode and the coupling mode.

The control and/or regulating unit 70 comprises a communication interface 72 provided at least for receiving a communication signal from an external unit that triggers a communication signal triggering the coupling mode of coupling unit 50 from an external unit. The communication interface 72 is a wireless and/or physical communication interface 72. The communication interface 72 is a cellular communications interface. The communication interface 72 is a Wi-Fi interface, a Bluetooth interface, a NFC interface, a USB interface, and/or the like. Preferably, the communication signal is a corresponding signal from the communication interface 72, in particular for establishing a communication link to the external unit. The external unit is an operator element (not shown). For example, the external unit is a smartphone, a tablet, a laptop, a remote control, and/or the like. The external unit communicates with the control and/or regulating unit 70 of the cable feeding device 10 via an application.

The control and/or regulating unit 70 is restricted in access. Switching to the coupling mode is access restricted. The operation mode is accessible. Alternatively, the coupling mode and the operation mode are restricted by the control and/or regulating unit 70. The control and/or regulating unit 70 is password protected. The communication interface 72 is triggered by the communication signal of the external unit to unlock the control and/or regulating unit 70. Alternatively and/or additionally, the cable feeding device 10 comprises at least one input field provided for the activation of the control and/or regulating unit 70.

FIG. 5 shows the pulling means set 16 having a plurality of different pulling means 14, 100, 102, 104. At least one of the pulling means 100, 102, 104 from the pulling means set 16 comprises a material different from the pulling means 14. At least one of the pulling means 100, 102, 104 from the pulling means set 16 comprises at least one pulling means cable 118, 120, 122 which is different from the pulling means cable 26 of the pulling means 14. At least one of the pulling means 100, 102, 104 from the pulling means set 16 comprises a material different from the pulling means 14. At least one of the pulling means 100, 102, 104 from the pulling means set 16 comprises at least one pulling means head 112, 114, 116 which is different from the pulling means head 24 of the pulling means 14. It is conceivable that the pulling means 14, 100, 102, 104 may have at least a different cross section. It is conceivable that the pulling means 14, 100, 102, 104 will have a different length. The pulling means 14, 100, 102, 104 each have at least one coupling element 60, 106, 108, 110 provided for coupling to a coupling unit 50 of the cable feeding device 10. The coupling elements 60, 106, 108, 110 of the pulling means set 16 are identical to each other. The coupling elements 60, 106, 108, 110 are each provided for coupling to the same coupling unit 50 of the cable feeding device 10.

What is claimed is:

1. A cable feeding device, comprising:
a transport unit, configured to transport a pulling device configured to retract cables into conduits, having at least one pulling device storage unit configured as a pulling drum, the pulling drum configured to store the pulling device in at least a largely enclosed manner; and
a coupling unit configured to detachably couple to the pulling device so as to enable a pulling device change.

2. The cable feeding device according to claim 1, wherein the transport unit is configured to provide a coupling mode wherein the coupling unit is provided for access sufficient to allow at least the pulling device change.

3. The cable feeding device of claim 1, wherein:
the transport unit is configured to provide a coupling mode in which at least one coupling element of the coupling unit configured to couple with the pulling device is arranged outside of a pulling device enclosure formed by the pulling device storage unit.

4. The cable feeding device according to claim 3, wherein:
the transport unit is configured to provide an operation mode; and
the at least one coupling element of the coupling unit configured to couple with the pulling device is arranged within the pulling device enclosure formed by the pulling device storage unit in the operation mode.

5. The cable feeding device according to claim 1, wherein:
the coupling unit comprises at least one coupling element configured to couple with the pulling device or with a coupling element of the pulling device; and
the coupling unit comprises at least one connecting element configured to arrange the coupling element on the pulling device storage unit and/or the transport unit.

6. The cable feeding device according to claim 5, wherein the connecting element is configured to be windable and is provided for pushing the pulling device out of the pulling device storage unit.

7. The cable feeding device of claim 2, wherein at least one control and/or regulating unit is configured to at least control the transport unit to execute the coupling mode and/or the coupling unit to establish or release the coupling with the pulling device.

8. The cable feeding device according to claim 7, wherein the at least one control and/or regulating unit comprises a communication interface configured at least to receive a communication signal from an external unit that triggers a communication signal from the coupling mode.

9. The cable feeding device of claim 7, wherein the control and/or regulating unit is restricted in access.

10. A system comprising:
a cable feeding device according to claim 1; and
at least one pulling device.

11. The system according to claim 10, further comprising:
a receiving unit adapted to deliver and/or receive directly upon unwinding and/or winding of the pulling device, in a coupling mode, the pulling device.

12. A pulling device configured to be used in the system according to claim 10, comprising:
a coupling element configured to couple to the coupling unit of the cable feeding device.

13. A set of pulling devices, comprising:
a plurality of pulling devices,
wherein
each of the plurality of pulling devices comprises a respective coupling element configured to couple to the coupling unit of the cable feeding device according to claim 1,
each of the plurality of pulling devices is defined by a respective set of properties, and
each of the respective set of properties are different from the other of the respective sets of properties.

14. The set of claim 13, wherein:
each respective set of properties includes a respective property set of at least one of flexural rigidity, type of material, length, cross section, and grip element; and
each of the respective property sets differs from at least one other of the respective property sets.

15. The cable feeding device of claim 1, wherein
the pulling device is configured as a fish tape; and
the coupling unit is configured to directly coupling to the pulling device.
